(19) United States
(12) Patent Application Publication
(10) Pub. No.: US 2014/0251166 A1
(43) Pub. Date: Sep. 11, 2014

(54) MANUALLY OPERATED PRESS

(71) Applicant: Hartmut Babiel, St. Georgen (DE)

(72) Inventor: Hartmut Babiel, St. Georgen (DE)

(21) Appl. No.: 14/233,473

(22) PCT Filed: Jul. 26, 2012
(86) PCT No.: PCT/DE2012/100225

§ 371 Date: Apr. 28, 2014

(30) Foreign Application Priority Data
Jul. 28, 2011 (DE) 102011080030.1

(51) Int. Cl. B30B 1/00; B30B 1/26

(52) U.S. Cl. CPC B30B 1/007; B30B 1/261
USPC 100/137

(57) ABSTRACT

A manually operated press includes a cam disc that is pivotably mounted about an axis, an actuation member that acts upon the cam disc for producing a pivoting movement, a press slide and a press stand that accommodates the press slide allowing it to perform a stroke movement. The pivoting movement triggered by the actuation member is converted by the cam disc into a stroke movement of the primary piston and is transferred to the press slide via the hydraulic line and the secondary piston.

The invention relates to a manually operated press, as is known, for example, from GB 437 540 (A). It comprises a cam disk which is mounted such that it can be pivoted about a pin, an actuating member in the form of a hand lever which acts on the cam disk in order to generate a pivoting movement, a press ram and a pressure column which receives the press ram in such a way as to make a stroke movement possible. In said manually operated press, the pivoting movement of the hand lever is therefore converted via the cam disk into a stroke movement of the press ram.

Manually operated presses are generally used for mounting serial components, the operator having to perform many pressing movements which follow one another. As a result of the fatigue which occurs in the process, it can occur that the work stroke is not carried out completely and faulty workpieces are produced as a result. This is guarded against by what are known as return stroke locks which prevent the return stroke of the press ram as long as a predetermined target position has not been reached.

Conventional manually operated presses which have a stroke lock are known from DE 43 14 062 A1, DE 199 59 627 A1 and DE 102 23 153 C1. In said presses, the force is transmitted from a hand lever to the press ram either via a toggle lever mechanism or via a combination of toothed rack and pinion.

Because of the design, the hand lever for operating the abovementioned presses is attached fixedly to the shaft of the gearwheel or the toggle lever, which frequently makes a flexible ergonomic arrangement of the actuating member impossible.

In said toothed rack presses, the transmission ratio of force and displacement remains constant during the entire press stroke. This means that the operator has to perform a great work movement for the advancing stroke before the actual pressing operation although no pressing force is yet applied. Great actuating forces result for the movement during the actual pressing operation, since the transmission ratio is not changed. The less widespread hydraulic manual presses also have this disadvantage.

With regard to pressing force and lever travel, said toggle lever presses have a ratio which is determined by the geometry of the toggle lever which is used. Here, the greater stroke of the press ram at the beginning of the work stroke and greater pressing forces with a small movement of the press ram shortly before the stretched position of the toggle lever are characteristic.

Mechanical latching mechanisms which are susceptible to faults and can be set to the respective work operation in a complicated manner are usually used in the described machines as return stroke lock. Simple presses of this type do not have an overload safeguard which prevents the application of excessively great pressing forces.

As an alternative, very complicated and electronically controlled brakes and clutches are used. Here, the control signals are derived from force and displacement sensors. In said presses, the stroke lock can take place at any position of the stroke, and an overload safeguard is thus also made possible. As a result of the construction, however, said machines are comparatively very complicated and expensive.

The above-described presses are widespread in industry and have also proven themselves during long practical use, but various improvements would certainly be desirable.

One disadvantage of the described presses consists in that the position and the actuating direction of the actuating member cannot be selected freely according to occupational ergonomic aspects. Since the actuating member is as a rule attached to the top of the machine, the gripping movement in order to reach the actuating member is far and high and makes fatigue-free working more difficult.

A further disadvantage consists in that the presses of the above design have a transmission ratio which is stipulated by the construction in a fixed manner and can be adapted only in a very limited manner to the force profile which is desirable for different work operations. The production of relatively long pressing-in connections or the punching of components with toggle lever presses often fails because the required pressing force is not available until briefly before the stretched position of the toggle lever is reached. Relatively great pressing forces cannot be achieved by way of said toothed rack presses and hydraulic presses, and the work movement of the operator during the advancing stroke is not ergonomic. The subsequent change of the transmission ratio on an existing machine is not possible. A further disadvantage consists in that the stroke locks which are used either operate imprecisely via a plurality of latching positions and can be set in a complicated manner, or else they are very complex and expensive.

A further disadvantage consists in that said presses do not have an overload safeguard which limits the maximum pressing force which can be applied to the workpiece.

A further disadvantage consists in that said presses do not have a device, by way of which the pressing-in speed can be limited.

A further disadvantage consists in that an automatic return of the press ram does not take place when a predetermined target position or target pressing force is reached.

The invention is based on the object of providing a manually operated press of the type mentioned at the outset, by way of which press the above problems are solved.

In particular, an inexpensive press is to be provided which permits any desired spatial arrangement and actuating direction of the actuating member, which makes any desired infinitely variable transmission ratio of the hand lever to the press ram possible, which transmission ratio can be adapted simply to different pressing operations, which has a stroke lock which is free of latching steps, an overload safeguard and a possibility for limiting the stroke speed, which has an automatic return of the press ram when a predetermined target position or target pressing force is reached, and which can be equipped with a simple, robust sensor system for monitoring, recording and documenting the pressing forces which occur.

A sensor system for recording the quality-relevant force/displacement profile in the control unit is known, for example, from DE 102 23 153 C1.

In a manually operated press of the type mentioned at the outset, this object is achieved by the characterizing features of claim 1. Advantageous refinements of the invention are described in the subclaims.

The pivoting movement which is triggered by the actuating member is accordingly converted by the cam disk into a stroke movement of the primary piston and is transmitted to the press ram via the hydraulic line and the secondary piston.

In order to ensure that the pressing movement is performed completely, a return stroke lock can be provided which is configured as unlockable non-return valve between the hydraulic cylinders.

As a result of the unlockable non-return valve, the press has an infinitely variable return stroke lock which does not have to be set for the respective work operation and which is unlocked mechanically when a predetermined target position of the ram is reached, or else is unlocked hydraulically when a target pressing force is reached via an adjustable pressure valve, and therefore initiates an automatic return of the press ram.

In order to achieve optimum occupational ergonomics for the operator, the actual press ram and the actuating unit for the primary cylinder are separated. As a result of the separation of the primary and secondary cylinder, the spatial arrangement and actuating direction of the actuating member can be selected freely.

Sensitive workpieces can be damaged easily by excessively great pressing forces or an excessively high pressing-in speed. In order to avoid this, the use of an adjustable throttling valve between the primary and working cylinder allows the pressing-in speed to be limited, and the adjustable pressure limiting valve prevents the application of excessively great pressing forces.

In order to monitor the forces which occur during the production of the press joint, the pressing force can be measured via a pressure sensor in the hydraulic circuit and can be compared with predetermined limit values.

The transmission ratio of force and displacement between the actuating member and press ram can be adapted in a simple way to different work operations in an infinitely variable manner by the use of a suitable cam disk. An adaptation of the geometry of the cam disk permits the optimization of the transmission at every point of the work stroke. The simple adaptation for different work operations is possible by way of the exchange of the cam disk. As an alternative, the adaptation of the transmission by way of the use of segments with a different gradient on the same cam disk is also possible.

Further advantages result from the exemplary embodiments which are described in the following text and are shown in the figures.

It goes without saying that the advantages which are stated in the preceding text and are still to be explained in the following text can be used not only in the specified combination but also on their own or in other combinations, without departing from the scope of the invention.

In the figures:

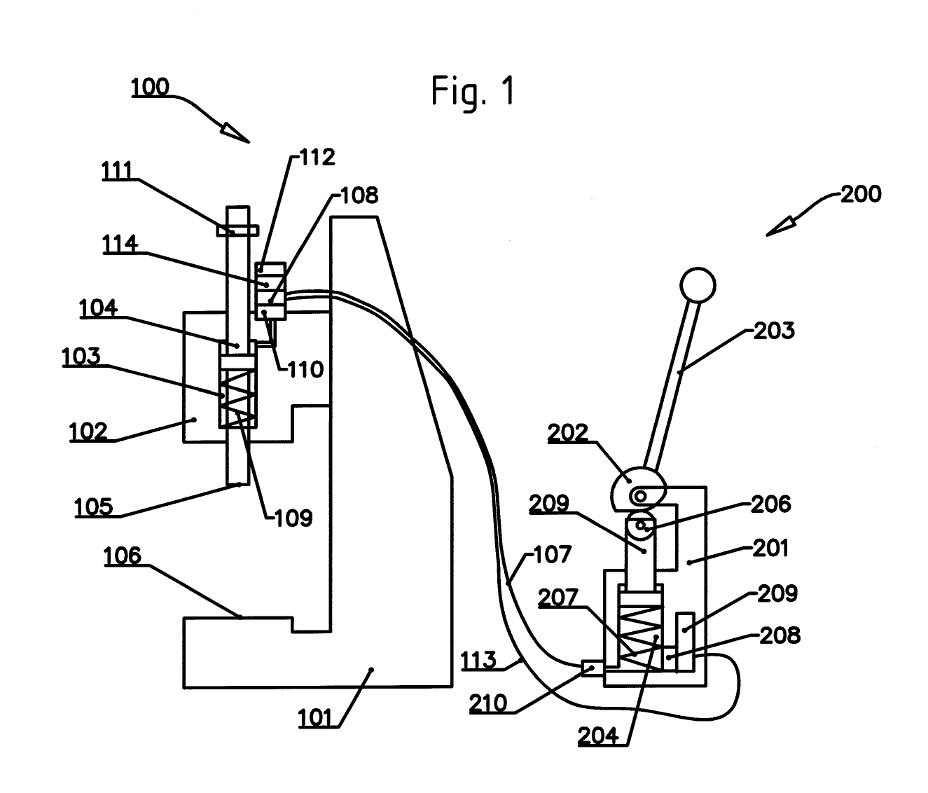

FIG. 1 shows a diagrammatic side view of the press according to the invention,

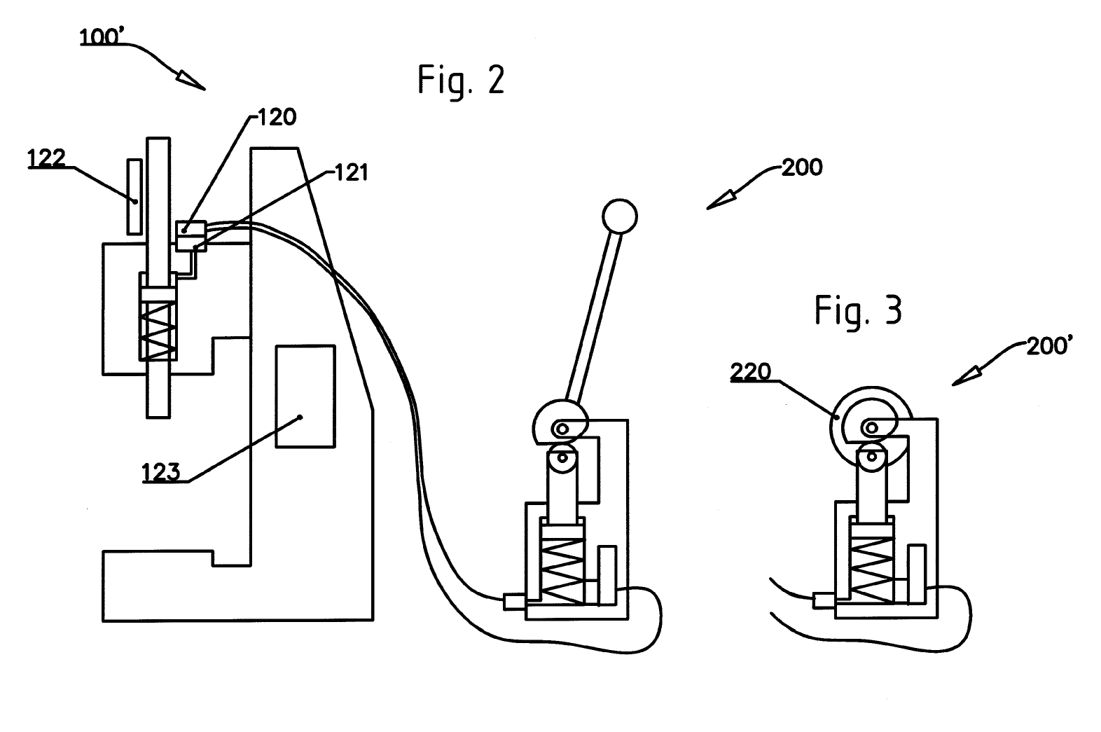

FIG. 2 shows one design variant of the press in an analogous manner to FIG. 1, and

FIG. 3 shows one design variant of the operating unit of the press in an analogous manner to FIG. 1 or FIG. 2.

The designation 100 denotes overall a press or working unit, and the designation 200 denotes an associated operating unit.

In FIG. 1, the working unit 100 has a pressure column 101 which stands, for example, on a subframe or a workbench. A head part 102 which can also be height-adjustable is connected to the pressure column 101.

A hydraulic secondary cylinder 103 is situated in the head part 102. The lower part of a secondary piston 104 of the secondary cylinder 103 is connected to a press ram 105, with which pressing is carried out in the direction of a working plate 106. The secondary cylinder 103 is loaded with pressure via a hydraulic line 107. The pressing speed can be limited via a throttling valve 108. A restoring spring 109 serves to restore the secondary cylinder 103 after a work stroke has taken place. However, a non-return valve 110 prevents the return stroke initially.

A setting part 111 is attached adjustably on the secondary piston 104 and, in conjunction with a mechanically actuated hydraulic valve 112, permits a return flow of the hydraulic oil via a return line 113 and therefore initiation of the return stroke after an adjustable pressing travel.

An adjustable and pressure-actuated hydraulic valve 114 which is connected to the secondary cylinder 103 likewise permits the return flow of the hydraulic oil via the return line 113 after the switchover at a set pressure, and therefore permits the initiation of the return stroke after an adjustable pressing force has been reached.

The operating unit 200 has a frame 201, to which a cam disk 202 is attached in a rotatably mounted manner and can be rotated by means of a hand lever 203. A hydraulic primary cylinder 204 is attached in the lower part of the frame 201. A pressure roller 206 is attached to a primary piston 205 of the primary cylinder 204, and a restoring spring 207 serves to restore the primary piston 205 of the primary cylinder 204 which is connected via a non-return valve 208 to a storage tank 209.

As a result of the actuation of the hand lever 203, the primary piston 205 is moved downward by the cam disk 204 and the pressure roller 206, and the pressure which is necessary for the pressing operation and is fed to the working unit 100 via the hydraulic line 107 is therefore generated. The pressing force which is applied to the workpiece can be limited by way of a pressure limiting valve 210.

Since the return of the pressurized hydraulic oil is prevented by the non-return valve 110 until the pressing operation in the working unit 100 is finished, the primary piston 205 can carry out a return stroke even in the case of a pressurized working part 100, hydraulic oil being replenished from the storage tank 209 via the non-return valve 208. In this way, large strokes in the case of relatively great pressing forces are made possible by multiple strokes of the operating unit 200, in particular in the case of great transmission ratios as are necessary for the achievement of great pressing forces.

A second preferred development of the press is shown in FIG. 2.

In this arrangement, the hydraulic valves 108, 110, 112, 114 on the working unit 100 are omitted. Instead, an electrically actuated hydraulic valve 120 with a working position, locking position and return position, a pressure sensor 121 and a displacement measuring system 122 are used which are connected to an electronic control unit 123. The arrangement allows the recording of the quality-relevant force/displacement profile in the control unit 123.

The pressing operation can then be enabled, the return stroke can be initiated or the press ram 105 can be fixed spatially via a suitable actuation of the hydraulic valve 120 by the control unit 123, depending on the force and/or displacement sensor signals and on the quality criteria of the pressing force profile of the press ram 105 which are stored in the control unit 123.

One preferred development of the operating unit 200 is shown in FIG. 3.

The hand lever 203 of the operating unit 200 is replaced by a simple electric motor 220 without a reversible direction of rotation. The press which is formed in this way permits individual strokes in the start/stop mode or permanent operation during permanent running. As a result of the selected construction, in contrast to conventional hydraulic presses, energy is consumed only when performing pressing work and not during standby. Since the return of the press ram already takes place at the preset pressing force or the predetermined pressing travel, a reversible direction of rotation of the motor for the return can be dispensed with, without overloading of the press needing to be feared.

### List of Designations

100 Working unit

101 Pressure column

102 Head part

103 Secondary cylinder

104 Secondary piston

105 Press ram

106 Working plate

107 Hydraulic line

108 Throttling valve

109 Restoring spring

110 Non-return valve

111 Setting part

112 Hydraulic valve

113 Return line

114 Hydraulic valve

120 Hydraulic valve

121 Pressure sensor

122 Displacement measuring sensor

123 Control unit

200 Operating unit

201 Frame

202 Cam disk

203 Hand lever

204 Primary cylinder

205 Primary piston

206 Pressure roller

207 Restoring spring

208 Non-return valve

209 Storage tank

210 Pressure limiting valve

220 Electric motor

1-14. (canceled)

15. A manually operated press, comprising:
a cam disk which is mounted pivotably about a pin;
an actuating member which acts on the cam disk in order to generate a pivoting movement;
a press ram;
a pressure column which receives the press ram in such a way as to make a stroke movement possible;
an operating unit having a primary cylinder which has a primary piston;
a secondary cylinder which has a secondary piston which is connected to the press ram; and
at least one hydraulic line providing hydraulic coupling between the primary cylinder and the secondary cylinder, wherein the pivoting movement which is triggered by the actuating member is converted by the cam disk into a stroke movement of the primary piston and is transmitted to the press ram via the hydraulic line and the secondary piston.

16. The press as claimed in claim 15, further comprising:
a return stroke lock which acts between the primary cylinder and the secondary cylinder.

17. The press as claimed in claim 16, wherein the return stroke lock includes an unlockable non-return valve.

18. The press as claimed in claim 16, wherein the return stroke lock is designed in such a way that a reverse movement is prevented before a defined pressing force and/or a predetermined position of the press ram are/is reached.

19. The press as claimed in claim 15, further comprising:
a restoring spring which acts on the primary piston and a storage tank which is connected to the primary cylinder via a non-return valve in such a way that the operating unit permits a return stroke of the primary piston, which return stroke is independent of the return stroke of the press ram, and therefore makes sequential multiple strokes possible.

20. The press as claimed in claim 15, wherein the operating unit is configured as a separate assembly and is arrangeable in a spatially separated manner from other components.

21. The press as claimed in claim 15, further comprising at least one of:
a pressure limiting valve for limiting the applied pressing force; or
a throttling valve for limiting the pressing-in speed, which act between the primary cylinder and the secondary cylinder.

22. The press as claimed in claim 15, further comprising:
a control unit which, by way of sensor signals, actuates a hydraulic valve which is installed between primary cylinder and secondary cylinder, wherein the press ram is positionable spatially at any point of a press stroke in the forward direction or a return stroke in the reverse direction.

23. The press as claimed in claim 22, further comprising:
a pressure sensor for measuring the hydraulic pressure or the pressing force in order to lock the return stroke until a predetermined pressing force is reached and/or in order to lock the press stroke if a maximum predetermined pressing force is exceeded.

24. The press as claimed in claim 22, further comprising:
a displacement measuring sensor for measuring the press stroke in order to lock the return stroke until a predetermined position of the press ram is reached and/or in order to lock the press stroke if a maximum predetermined press travel is exceeded.

25. The press as claimed in claim 22, wherein the control unit is designed in such a way as to determine quality of the press joint from pressing forces which are applied during performance of the pressing operation.

26. The press as claimed in claim 22, wherein control unit is designed in such a way that the return stroke or a further press stroke is enabled only when the control unit determines a desired level of pressing.

27. The press as claimed in claim 15, wherein the cam disk is exchangeable.

28. The press as claimed in claim 15, wherein the actuating member includes a hand lever.

29. The press as claimed in claim 15, wherein the actuating member includes an electric motor.
